(19) United States
(12) Patent Application Publication
(10) Pub. No.: US 2015/0142657 A1
(43) Pub. Date: May 21, 2015

(54) LINKING PHYSICAL CARD TO VIRTUAL CARD ACCOUNT METHOD AND APPARATUS

(71) Applicant: MASTERCARD INTERNATIONAL INCORPORATED, Purchase, NY (US)

(72) Inventors: Jazmin SAGASTIVERZA, Bronx, NY (US); Adrian BOTTA, Teaneck, NJ (US); Pranav GANDHI, Dormer Park (SG); Joshua LAGAN, West Simsbury, CT (US); Joel LASKO, Southbury, CT (US); Maria Emilia ORDOÑEZ, Quito (EC); Jon-Paul WITKOP, Fairport, NY (US)

(73) Assignee: MASTERCARD INTERNATIONAL INCORPORATED, Purchase, NY (US)

(21) Appl. No.: 14/086,693

(22) Filed: Nov. 21, 2013

(51) Int. Cl. G06Q 20/22; G06Q 20/34

(52) U.S. Cl. CPC G06Q 20/29; G06Q 20/351
USPC 705/44

(57) ABSTRACT

A system, method, and computer-readable storage medium configured to enable a cardholder to perform a financial transaction with virtual payment card when presenting a linked physical payment card.

### BACKGROUND

1. Field of the Disclosure

Aspects of the disclosure relate in general to financial services. Aspects include an apparatus, system, method and computer-readable storage medium to enable the pooling and sharing of funds to cover shared expenses.

2. Description of the Related Art

When individuals have shared expenses, a dilemma of funding the shared expenses is created.

In some instances, multiple individuals can pay a single bill by using multiple individual payment cards. For example, when a group of individuals go out to dinner at a restaurant, each person may present a payment card. As this creates an additional burden on the restaurant, many restaurants limit the number of payment cards that can be presented with a bill. Additionally, the fairness of the restaurant scenario is in question when people order entrees of different costs, as restaurants usually evenly divide the bill among payers.

Even worse, many vendors such as department stores, supermarkets, “big box” stores or gas stations will not accept multiple payment cards for a single transaction. In these instances, usually one person receives cash from their cohorts and then pays the vendor directly with the cash or a payment card, such as a prepaid gift card or other physical payment card 100 as shown in FIG. 10.

More complex is when multiple individuals are paying for different expenses for a joint project. For example, if a number of people are going on a camping trip, one person may be assigned to buy groceries, another to buy camping gear, and yet another person may have to pay for gas and miscellaneous items. Keeping track of total expenses and evenly funding the enterprise becomes a logistical nightmare.

### SUMMARY

Embodiments include a system, device, method and computer-readable medium to enable a cardholder to perform a financial transaction with virtual payment card when presenting a linked physical payment card. An apparatus embodiment includes a processor and a network interface. The processor is configured to create a virtual payment card, the virtual payment card having a unique identifier and a balance. The processor links a primary account number of a physical payment card to the virtual payment card. A network interface is configured to receive a financial transaction request message. The financial transaction request message contains a transaction amount and the primary account number of the physical payment card. The processor substitutes the primary account number of the physical payment card with the unique identifier of the virtual payment card. A financial transaction for the transaction amount is approved or declined using the substituted unique identifier. the network interface transmits an approval message, when the financial transaction is approved, and transmits a decline message when the financial transaction is declined.

### BRIEF DESCRIPTION OF THE DRAWINGS

FIG. 1 illustrates an embodiment of a system configured to enable the pooling and sharing of funds to cover expenses.

FIG. 2 depicts an apparatus embodiment configured to enable the pooling and sharing of funds to cover expenses.

FIG. 3 is a flowchart of an embodiment to link a virtual payment card account with a physical payment card.

FIG. 4 is a flowchart of an embodiment to process a transaction using a virtual payment card account when a physical payment card is presented.

FIGS. 5A-5B flowchart a method embodiment to enable the pooling and sharing of funds to cover expenses over a limited time period.

FIG. 6 is a flowchart of an embodiment to enable multiple payers to spend shared funds.

FIG. 7 illustrates a flowchart of an embodiment to enable a payer to spend shared funds and notify contributors of the payment on their behalf.

FIG. 8 depicts a method embodiment to enable a contributor to supplement shared funds.

FIG. 9 illustrates a flowchart of an embodiment to enable return of funds when contributors depart.

FIG. 10 illustrates an example payment card.

### DETAILED DESCRIPTION

One aspect of the disclosure includes the realization that individuals may be able to pool their funds in real-time. Embodiments enable users to dynamically pool and share funds to cover joint expenses. Conceptually, a basket is a virtual payment card or electronic wallet, which can be funded by contributors. The creator of the basket is authorized to make payments using contributed funds within the basket. The basket creator may also nominate and authorize others to make payments with the funds pooled within the basket.

By using a basket, contributors can more fairly allocate expenses. By facilitating multiple payers from a basket, collaborators can more easily share common funds. Moreover, users can make payments to multiple vendors while still keeping track of their shared expenses.

In another aspect of the disclosure, embodiments notify and keep contributors informed on payments made on their behalf with the contributed funds.

These and other benefits may be apparent in hindsight to one of ordinary skill in the art.

Embodiments of the present disclosure include a system, method, and computer-readable storage medium configured to pool and share funds to cover joint expenses.

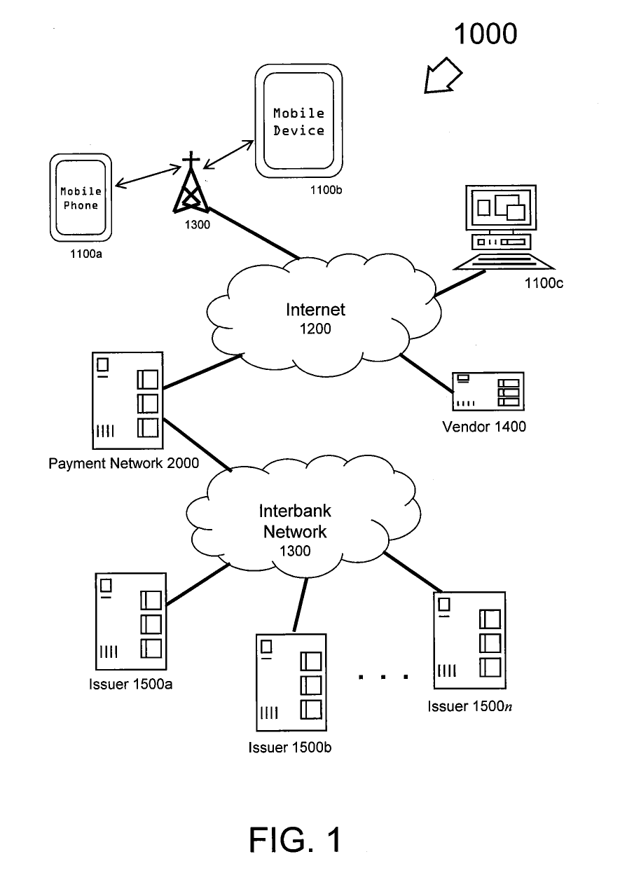

FIG. 1 illustrates an embodiment of a system 1000 configured to enable the pooling and sharing of funds to cover expenses, constructed and operative in accordance with an embodiment of the present disclosure. System 1000 includes consumers using a plurality of computing devices 1100a-c to connect to a payment network 2000 via a data network 1200, such as the Internet. Details and example uses of payment network 2000 are discussed below.

In some embodiments, consumers may use a mobile phone 1100a, mobile device 1100b, or personal computer 1100c and connect to payment network 2000 via a wireless data network 1300 capable of connecting to the Internet. It is understood that wireless data network 1300 may be a wireless data provider such as a cellular telephone network, wireless local area network (WLAN or “WiFi networks”), satellite data networks, and the like. Computing devices 1100 include mobile devices such as mobile telephones, tablet computers, laptop computers, “ultra books” or other portable computing device known in the art capable of communicating to payment network 2000.

As shown in FIG. 1, payment network 2000 may be connected to vendors 1400 and issuers 1500a-n via an interbank network. In some embodiments, payment network 2000 may be located at payment network 2000 or at an issuer 1500.

A vendor 1400 is any merchant or service provider, as is known in the art.

Payment network 2000 is a network capable of processing payments electronically. An example payment network 2000 includes MasterCard International Incorporated.

Issuers 1500a-n include any banks and other entities that issue payment cards 100.

An interbank network 1300 is a computer network that connects different banking institutions. For example, an Automated Teller Machine (ATM) consortium network is an interbank network.

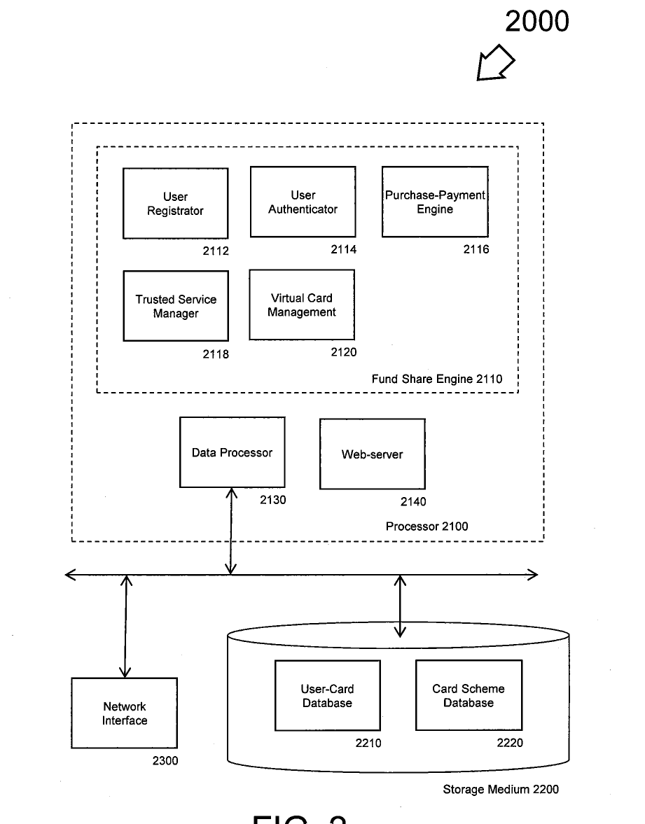

Embodiments will now be disclosed with reference to a block diagram of an exemplary payment network 2000 of FIG. 2, constructed and operative in accordance with an embodiment of the present disclosure. Payment network 2000 is configured enable the pooling and sharing of funds to cover expenses.

Payment network 2000 may run a multi-tasking operating system (OS) and include at least one processor or central processing unit (CPU) 2100, a non-transitory computer-readable storage medium 2200, and a network interface 2300.

Processor 2100 may be any central processing unit, microprocessor, micro-controller, computational device or circuit known in the art.

It is well understood by those in the art, that the elements of FIG. 2 may be implemented as hardware, firmware, or as software instructions and data encoded on a non-transitory computer-readable storage medium 2200.

As shown in FIG. 2, processor 2100 is functionally comprised of a fund share engine 2110, a web-server 2140, and a data processor 2130.

Fund share engine 2110 may further comprise: user registrator 2112, user authenticator 2114, purchase-payment engine 2116, trusted service manager 2118, and basket management 2120. User registrator 2112 enables consumers to register and input their associated payment card information into a user-card database 2210. User authenticator 2114 is an interface that allows users to authenticate themselves with fund share engine 2110. Purchase-payment engine 2116 performs payment and purchase transactions to fund a basket or make payments from a basket. Trusted service manager 2118 provides the fund share engine 2110 secure element provisioning with mobile devices, such as mobile phone 1100a or mobile device 1100b. Basket management 2120 enables the fund share engine 2110 to determine the basket balance, and tracks the contributors to the basket. These structures may be implemented as hardware, firmware, or software encoded on a computer readable medium, such as storage media 2200. Further details of these components are described with their relation to method embodiments below.

In some embodiments, payment-purchase engine 2116 and trusted service manager 2118 may be a service separate from payment network 2000, and may exist at payment network 2000 or issuer 1500.

Data processor 2130 interfaces with storage media 2200 and network interface 2300. The data processor 2130 enables processor 2100 to locate data on, read data from, and write data to, these components.

Web-server 2140 is any computing device configured to deliver web pages or other content across the Internet 1200 via network interface 2300; user devices 1100 may communicate with a fund share engine 2110 via the World-Wide-Web protocol and web-server 2140.

Network interface 2300 may be any data port as is known in the art for interfacing, communicating or transferring data across a computer network, examples of such networks include Transmission Control Protocol/Internet Protocol (TCP/IP), Ethernet, Fiber Distributed Data Interface (FDDI), token bus, or token ring networks. Network interface 2300 allows payment network 2000 to communicate with internet 1200, consumer 1100, consumers using mobile payment devices 1100d-e, interbank network 1300, payment network 2000, and issuers 1500a-n.

Computer-readable storage media 2200 may be a conventional read/write memory such as a magnetic disk drive, floppy disk drive, optical drive, compact-disk read-only-memory (CD-ROM) drive, digital versatile disk (DVD) drive, high definition digital versatile disk (HD-DVD) drive, Blu-ray disc drive, magneto-optical drive, optical drive, flash memory, memory stick, transistor-based memory, magnetic tape or other computer-readable memory device as is known in the art for storing and retrieving data. Significantly, computer-readable storage media 2200 may be remotely located from processor 2100, and be connected to processor 2100 via a network such as a local area network (LAN), a wide area network (WAN), or the Internet 1200.

In addition, as shown in FIG. 2, storage media 2200 may also contain a user-card database 2210, and a card scheme database 2220. User-card database 2210 is configured to store information associating users with baskets and payment cards. Users may be individuals, businesses, or other entities. For individual user accounts, users may be associated with one or more baskets. Baskets may accept contributions from multiple individual users through the processes described below. Card scheme database 2220 facilitates the look-up of issuers 1500 as described below.

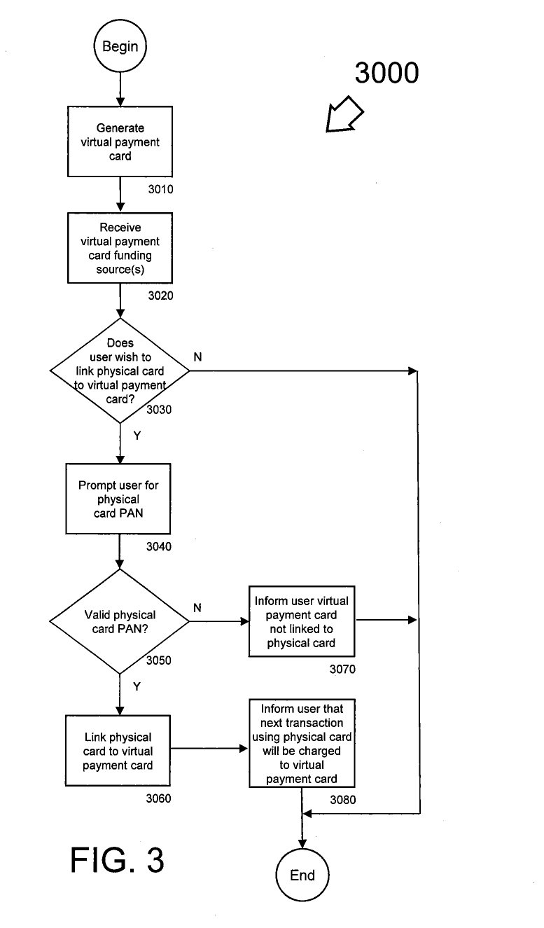

It is understood by those familiar with the art that one or more of these databases 2210-2220 may be combined in a myriad of combinations. The function of these structures may best be understood with respect to the flowcharts of FIGS. 3-9, as described below.

We now turn our attention to method or process embodiments of the present disclosure, FIGS. 3-9. It is understood by those known in the art that instructions for such method embodiments may be stored on their respective computer-readable memory and executed by their respective processors. It is understood by those skilled in the art that other equivalent implementations can exist without departing from the spirit or claims of the disclosure.

It is further understood that embodiments of the present disclosure may be applied to a variety of payment card types, including credit, debit, charge, prepaid cards and electronic wallets (subject to any applicable financial regulatory restrictions and requirements). An electronic wallet is a program or service where users can store and control their online shopping information, like logins, passwords, shipping address and payment card details, in one central place.

Some embodiments may be restricted to either prepaid cards or debit cards. Other embodiments allow pooling of funds from one type of payment card to another; for example, a cash advance from a credit card may be pooled with funds from a debit card into a basket (subject to any applicable financial regulatory restrictions and requirements). Similarly, in addition to card-based accounts, funding sources may also include any form of electronic payment account, such as a bank account or money market account.

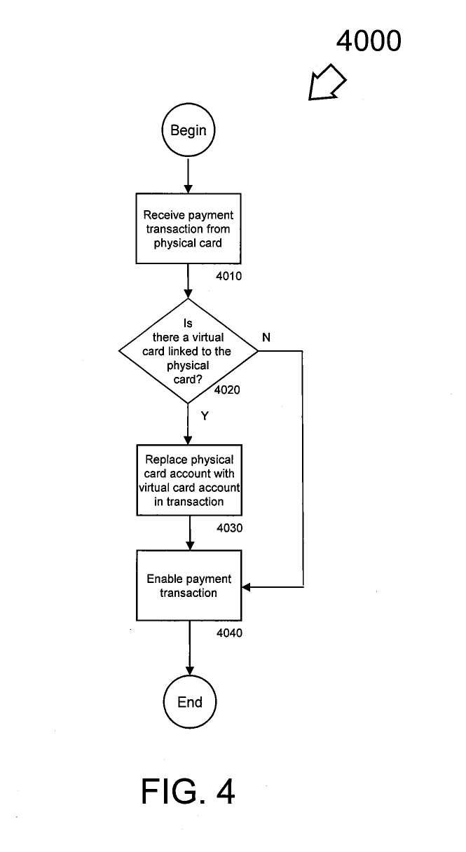

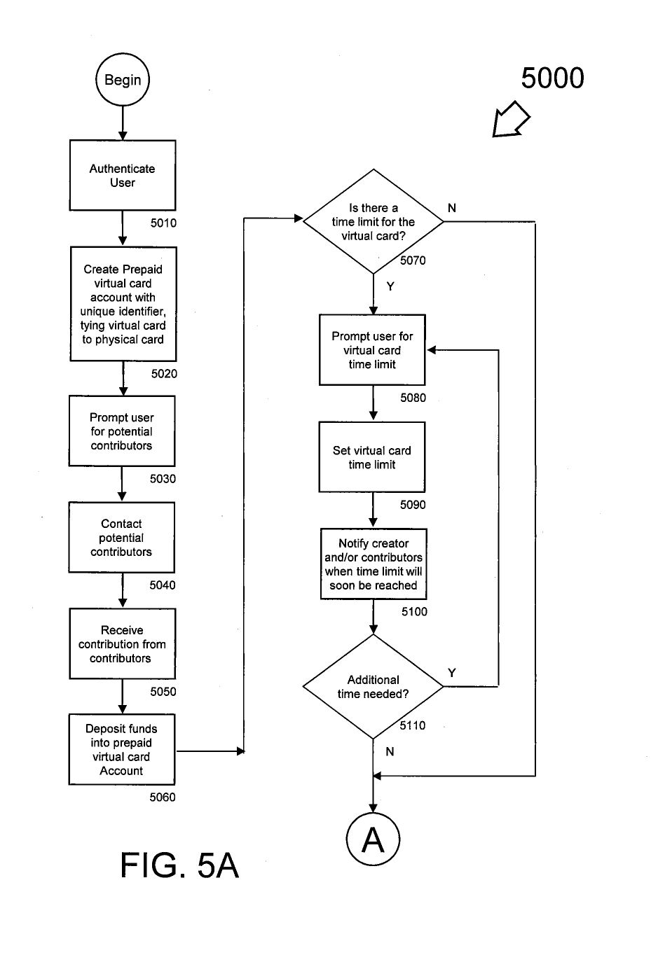

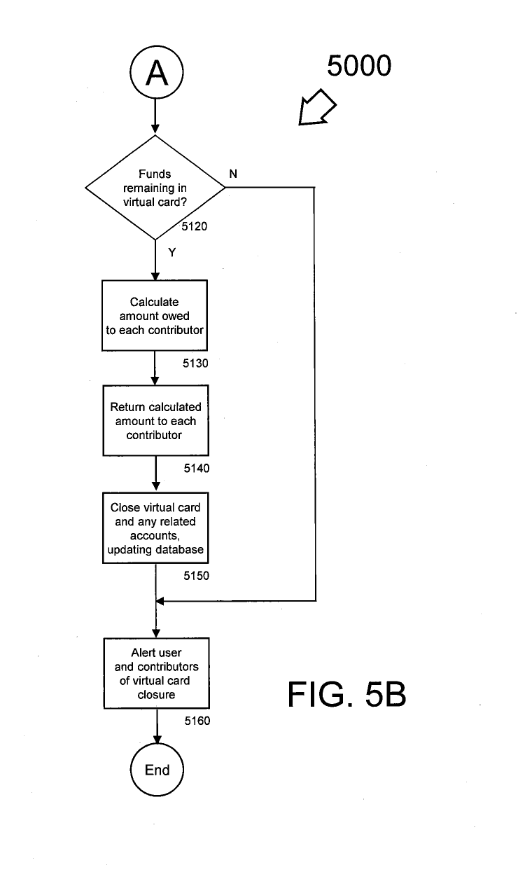

FIGS. 3 and 4 illustrate embodiments that enable the access and use of virtual payment cards via a physical payment card. FIGS. 5-9 illustrate embodiments that enable the pooling of funds on to virtual payment cards. It is understood by those familiar with the art that these embodiments may be used in conjunction or individually.

Furthermore, it is understood that the processes of FIGS. 3 and 4 may occur at either a payment network 2000 or issuer 1500. For the sake of example only, an embodiment will be described using payment network 2000.

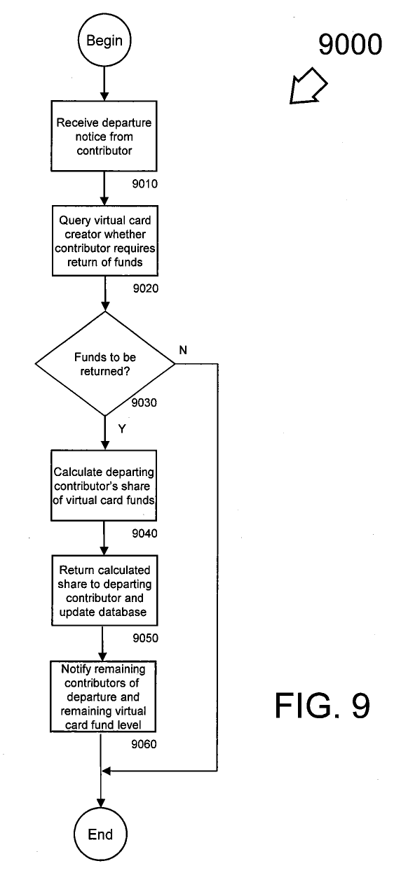

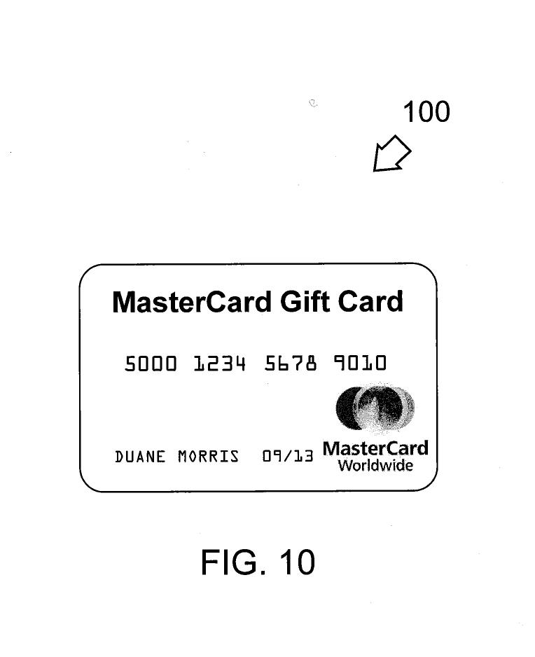

FIG. 3 is a flowchart of an embodiment method 3000 to link a virtual payment card account with a physical payment card, constructed and operative in accordance with an embodiment of the present disclosure. In many physical (“bricks-and-mortar”) vendor 1400 locations, virtual payment cards are not accepted. The embodiment of FIG. 3 links a virtual payment card to a physical payment card. After the linking, the first time the linked physical payment card is used in a financial transaction, funds from the virtual payment card are accessed using a process such as the one described in FIG. 4. After the financial transaction, any excess funds may be returned to contributors to the virtual payment card using the process described in FIG. 9.

Returning to FIG. 3, initially a virtual payment card is generated by virtual card management 2120, block 3010. The virtual payment card has a unique identifier and a virtual payment card balance. In some embodiments, the virtual payment card may be a virtual prepaid card.

The virtual payment card is funded at block 3020. The virtual payment card may be generated and funded may occur by any methods known in the art, including the virtual payment card generation methods described within this disclosure.

The user, which may be the cardholder that requests the virtual card creation, is queried on whether they wish to allow access to the virtual payment card funds via a physical payment card, which links a physical payment card to the virtual payment card funds, decision block 3030.

If the user does not wish to link a physical card to the virtual payment card, process 3000 ends. Otherwise, the process continues at block 3040.

At block 3040, the user is prompted to provide a physical payment card number that uniquely identifies a record in a central database at the card issuer, where a balance is recorded. This unique identifier is commonly referred to as a Primary Account Number (PAN). The prompting may occur in a variety of different ways. The user could be prompted to enter the Primary Account Number into a payment application running on a mobile phone 1100a, swipe a magnetic strip of a physical payment card 100, present physical payment card to a Near-Field Communications card reader, visually scan the physical payment card, or any other method of providing the Primary Account Number known in the art.

The presented physical card PAN is verified to determine whether the number is valid, at block 3050. A Primary Account Number may be invalid for a number of reasons—the number does not exist, the number is linked to a closed account, or any other reason. If the card is invalid, the user is informed that the physical payment card has not been linked, block 3070. In some embodiments, the user may be prompted for another physical payment card, and the process flow returns to block 3040; otherwise, process 3000 ends.

At block 3060, the user-card database 2210 is updated to link the physical payment card 100 to the virtual payment card. The primary account number of the physical payment card to the virtual payment card. With this update, the next time payment processor 2000 receives a financial transaction with the physical payment card 100, payment processor substitutes the virtual payment card in the transaction, instead of using the PAN from the physical payment card 100. The user is informed of the linking at block 3080, and the process ends.

FIG. 4 is a flowchart of an embodiment 4000 to process a transaction using a virtual payment card account when a physical payment card is presented, constructed and operative in accordance with an embodiment of the present disclosure.

At block 4010, payment network 2000 receives a payment transaction message from a vendor 1400 (through a merchant bank) via the network interface 2300. In issuer 1500 embodiments, the transaction message may be received from a payment network 2000. In either case, the transaction message includes a transaction amount, an identifier to identify the vendor requesting the transaction, and a Primary Account Number (or other unique identifier) of a payment card. In most transactions, the Primary Account Number is for a physical payment card 100 issued to a cardholder participating in the transaction.

At block 4020, purchase-payment engine 2116 checks either with virtual card management 2120 or user-card database 2210 to determine whether a virtual card number has been linked to the Primary Account Number. If not, the payment transaction takes place at block 4040 with the Primary Account Number.

If a virtual card number has been linked to the Primary Account Number, the virtual card account number substitutes the physical card Primary Account Number in the transaction, block 4030, and the payment transaction takes place with the virtual card number at block 4040, including an approval or decline of payment transaction using the substituted unique identifier. As part of block 4040, the network interface 2300 transmits either an approval message or decline message depending on whether the payment transaction is approved or declined.

FIGS. 5A-5B flowchart a method 5000 in which an embodiment enables the pooling and sharing of funds to cover expenses over a limited time period through payment network 2000, constructed and operative in accordance with an embodiment of the present disclosure. Process 5000 may be referred to as virtual card creation.

At block 5010, user authenticator 2114 receives information from user 1100 to authenticate the user against data stored in the user-card database 2210. Embodiments may authenticate users using any method known in the art including, but not limited to: passwords, cardkeys, optical recognition, fingerprint identification, and facial recognition.

Virtual card management 2120 creates a prepaid payment virtual card account with a Primary Account Number, block 5020. With such a virtual payment card, the Primary Account Number uniquely identifies a record in a central database at the card issuer, where the balance is recorded. As part of the virtual card account creation at block 5020, virtual card management 2120 associates the created virtual card with an issuer 1500. The issuer may be predetermined in advance, or in some embodiments, the user may select an issuer 1500 of their choice.

In some embodiments, the virtual card account creation at block 5020 may be the same or similar to process 3000 of FIG. 3.

Additionally, virtual card management 2120 may also generate ancillary information normally associated with a payment card. Such information may vary, but the most common include: Name of virtual card holder, account number, Expiration date, and a security code (such as a Card Verification Value or “CVV” code). In some instances, the ancillary information associated with the account is predetermined and provided by the issuer and then associated with the account number.

In some embodiments, the user may be prompted to name or attach a descriptive label to the virtual card. For example, a user may decide to name the virtual card after the intended fund payment activity, such as “Family trip to Vienna” or “Denise's surprise birthday party expenses.” In yet other embodiments, virtual card management 2120 includes a budgeting apparatus that allows the user to elaborate details on the intended activity. For example, the type of expenses including their currency amounts may be specified for the trip to Vienna: train tickets $100, hotel charges $50, sightseeing expenses $50=total $200.

The virtual card information is stored at user-card database 2210.

The user is prompted to list contributors for the virtual card, block 5030. The contributors may be added via a variety of different ways. For example, users may be prompted to add potential contributors via their contacts on the mobile device 1100, via social network contacts, telephone numbers, e-mail addresses or any other electronic identifier known in the art.

At block 5040 fund share engine 2110 contacts all the specified potential contributors requesting their contribution to the virtual card. If the potential contributor is a known user that has specified a designated contact method in user-card database 2210, fund share engine 2110 contacts the potential contributor via the designated contact method. Contact methods may occur via an application running on mobile device 1100, e-mail, Short Message Service (SMS), text messages, voicemail messages, telephone calls, social networking service, or any other contact method known in the art.

Note that some embodiments skip blocks 5030 and 5040, and may receive contributions to the virtual card without making the request. In such embodiments, contributors may look up virtual cards via their “friends” contacts or from the description label attached to the virtual card.

At block 5050, purchase-payment engine 2116 processes contributions are received from contributors. Contributors may be able to send contributions in a myriad of ways. Contributors can contribute from their debit card accounts, credit card accounts, electronic funds transfer, or any other electronic method known in the art. In certain embodiments, contributions from credit card accounts, the contribution are considered a cash advance. In alternate embodiments, the contribution from certain types of accounts may have transaction fees attached to cover the overhead of the transaction.

Additionally, when contributions are made, the virtual card management 2120 associates a record of the contribution (along with the amount, contributor, and contributor contact information) with the virtual card information in user-card database 2210.

Purchase-payment engine 2116 deposits contributions into the virtual card at block 5060, and process 5000 ends. Contributions may be considered as a deposit made to the balance of a virtual prepaid paid card.

At decision block 5070, the fund share engine 2110 determines whether a time limit is set for the virtual card. This determination may be made in several different ways. In some embodiments, an automatic expiry time/date is enforced. In yet other embodiments may combine the two. For illustrative purposes only, the embodiment of FIGS. 5A-5B illustrate an embodiment in which the user sets a time limit for the virtual card.

At block 5080, the virtual card management 2120 prompts the user for a virtual card time limit or expiry time. The time limit is set at block 5090, and when the time limit will soon be reached, at block 5100, a warning notification is sent to the virtual card creator and/or contributors. The warning notification may be sent at a fixed time before virtual card expiry, such as 15-minutes, or the virtual card creator may specify a time they want to be informed, for example a day before the virtual card expires. Some embodiments prompt the virtual card creator to determine whether additional time is needed, at block 5110. If more time is needed, the process flow returns to block 5080, or otherwise continues to block 5120 on FIG. 5B.

When the time period expires, virtual card management 2120 determines if funds remain in the virtual card, block 5120. If no funds remain, the process continues at block 5160.

If funds within the virtual card remain unspent, as determined at block 5120, the funds are returned to the contributors. At block 5130, virtual card management 2120 calculates the amount owed to each contributor. Depending upon the implementation, the remaining unspent funds may be divided evenly. For example, if Denise, Karin and James each contributed to the virtual card, each would receive equal (⅓) share of the remaining funds. It is understood by those in the art that an approximate equal amount may be distributed—i.e., if a dollar remains, Denise may receive $0.34, Karin receives $0.33, and James receives $0.33, as fractional cents are not distributed. Alternatively, funds may be returned on a proportional basis depending upon each contributor's contribution. An example of the latter embodiment would work as follows. If Denise contributed 50% of the original funds, Karin 30%, and James 20%, Denise would receive 50% of the remaining unspent funds, while Karin would receive 30%, and James would each receive 20%. Similarly, an approximate proportional amount may be returned, as fractional cents are not distributed. The calculated amount is returned to each contributor at block 5140. The virtual card and any related accounts are closed, and the user-card database 2210 is updated accordingly at block 5150.

In some embodiments, a service fee may be deducted from the amount returned to each contributor.

The user and all contributors are notified of the virtual card closure at block 5160, and the process ends.

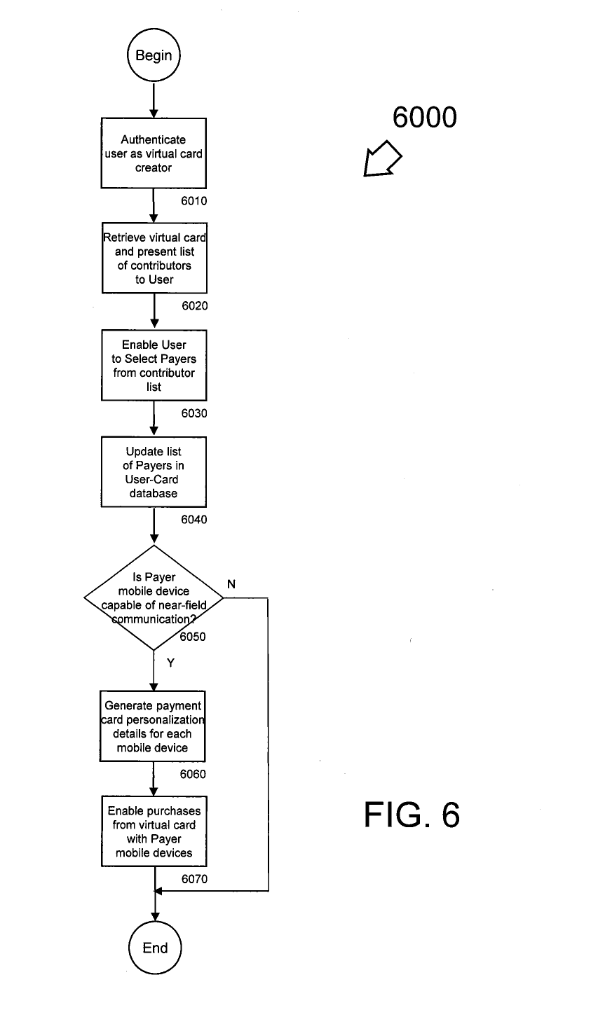

Initially, in the process described above, the user from the virtual card creation process 5000 defaults to being a person authorized to spend contributed funds from the virtual card, which will henceforth be referred to as a “payer.” Additionally, it is assumed that contributors are not always authorized to spend the contributed funds. More likely, the default is more likely that contributors are not allowed to spend contributed funds. Moving to FIG. 6, method 6000 enables the virtual card creator to designate multiple payers to spend shared funds, constructed and operative in accordance with an embodiment of the present disclosure. It is understood by those familiar with the art that in some embodiments, payers are designated by the virtual card creator from the set of contributors. In other embodiments, payers are not contributors at all, but trusted individuals. In yet another embodiment, some or all contributors are automatically payers.

Furthermore, the embodiment described below supports mobile devices capable of near-field communication (NFC). Near field communication is a set of standards for smartphones and similar devices to establish radio communication with each other by touching them together or bringing them into close proximity.

At block 6010, user authenticator 2114 receives information from virtual card creator 1100 to authenticate the user against virtual card data stored in the user-card database 2210. Similar to block 5010 above, embodiments may authenticate users using any method known in the art including, but not limited to: passwords, cardkeys, optical recognition, fingerprint identification, and facial recognition.

The virtual card management 2120 retrieves the virtual card information from user-card database 2210, including a contributor list which is presented to the authenticated virtual card creator, block 6020

Fund share engine 2110 enables the virtual card creator to select payers from the contributor list, block 6030. In some embodiments, the virtual card creator may authorize payers from other lists, which include non-contributors.

Once the payers are selected, an updated list of payers associated with the virtual card is recorded in the user-card database 2210, block 6040. Fund share engine 2110 contacts all the specified potential contributors requesting their contribution to the virtual card. If the newly authorized payer has specified a contact method in user-card database 2210, fund share engine 2110 alerts the newly authorized payers via their designated contact method. Contact methods may occur via an application running on mobile device 1100, e-mail, Short Message Service (SMS), text messages, voicemail messages, telephone calls, or any other contact method known in the art.

If a payer's mobile device is capable of near-field communication, as determined at block 6050, virtual card management 2120 generates a payment card personalization details for each mobile device, block 6060. Such personalization details may include a separate PAN for each mobile device, which enables purchases from the virtual card by the payer mobile device, and subsequent tracking of which payer is making the payment, block 6070.

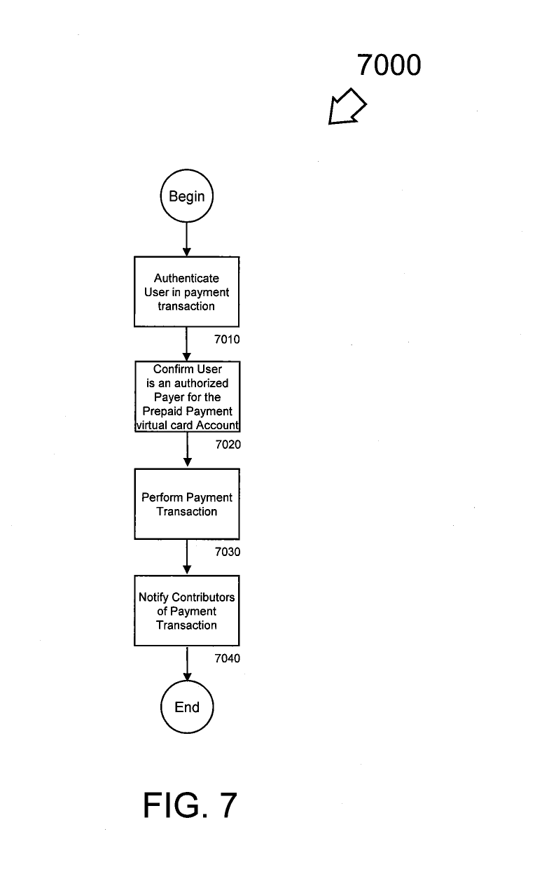

When contributors pool funds for a purpose, they expect that their money is used wisely; process 7000 in FIG. 7 illustrates an embodiment to notify contributors of a payment made on their behalf, constructed and operative in accordance with an embodiment of the present disclosure.

At block 7010, user authenticator 2114 receives information to authenticate the payer against virtual card data stored in the user-card database 2210. Similar to blocks 5010 and 6010 above, embodiments may authenticate users using any method known in the art including, but not limited to: passwords, cardkeys, optical recognition, fingerprint identification, and facial recognition.

The virtual card management 2120 confirms that the user is an authorized payer for the virtual card at block 7020.

The payment transaction is performed by purchase-payment engine 2116 at block 7030.

Once the payment is completed, the contributors associated with the virtual card are informed about the payment transaction, block 7040. In embodiments where each payer mobile device is assigned their own PAN, the contributor may be notified about which payer made the payment. Fund share engine 2110 alerts the contributors via their designated contact method. Contact methods may occur via an application running on mobile device 1100, e-mail, Short Message Service (SMS), text messages, voicemail messages, telephone calls, or any other contact method known in the art.

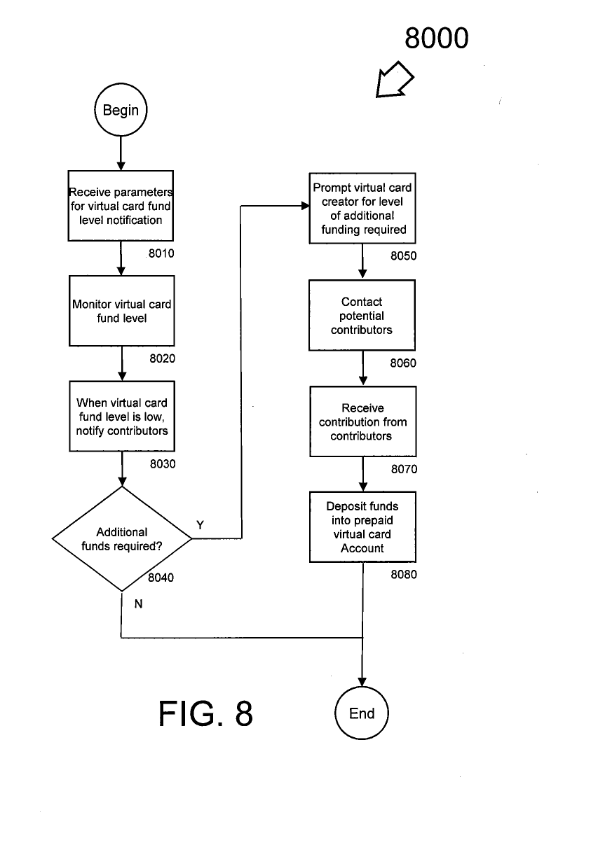

Virtual cards may be used to pool funds for a variety of different shared activities. Sometimes, when remaining virtual card funds run low, contributors may be asked to supplement the shared funds. FIG. 8 depicts a method 8000 to enable contributors to supplement shared funds, constructed and operative in accordance with an embodiment of the present disclosure.

In such an embodiment, virtual card management 2120 may receive parameters for when to notify the creator of diminishing shared virtual card funds, block 8010. This amount may be set at various levels according to the intended shared activity. The virtual card creator may specify that an alert be sent when funds reach a specific threshold level. For example, the creator may want an alert when funds fall less than $100. Virtual card management 2120 would monitor the virtual card fund level, block 8020, and notify contributors when the virtual card fund level falls below the $100 threshold, block 8030.

If additional funds are required for the shared activity as determined at decision block 8040, the virtual card creator is prompted for the level of additional funding required, block 8050.

The contributors are notified of their share of additional funds, block 8060, and once the contribution is received, block 8070, the funds are deposited into the prepaid payment virtual card account, block 8080. Process 8000 then ends.

During a shared activity, such as a drinks outing, a virtual card contributor may decide to depart early. In such instances, the contributors may be refunded their share of the remaining funds. FIG. 9 illustrates a flowchart of a process 9000 to enable return of funds when contributors depart, constructed and operative in accordance with an embodiment of the present disclosure.

In this embodiment, virtual card management 2120 receives a departure notice from a contributor, block 9010. Virtual card management 2120 queries the virtual card creator whether the contributor requires the return of funds, block 9020.

If no funds are to be returned, as determined at block 9030, the process ends.

If funds are to be returned, as determined at block 9030, funds are returned to the departing contributor. At block 9040, virtual card management 2120 calculates the amount owed to the contributor. Depending upon the implementation, the remaining unspent funds may be divided evenly. Alternatively, funds may be returned on a proportional basis depending upon each contributor's contribution.

The calculated amount is returned to the departing contributor at block 9050, and the user-card database 2210 is updated accordingly. If the departing contributor was also designated as a payer, their payer status is terminated; their related account its associated PAN is closed.

The remaining contributors are notified of the departure, and informed about the remaining virtual card fund level, block 9060. Process 9000 then ends.

The previous description of the embodiments is provided to enable any person skilled in the art to practice the disclosure. The various modifications to these embodiments will be readily apparent to those skilled in the art, and the generic principles defined herein may be applied to other embodiments without the use of inventive faculty. Thus, the present disclosure is not intended to be limited to the embodiments shown herein, but is to be accorded the widest scope consistent with the principles and novel features disclosed herein.

What is claimed is:

1. A method comprising:
creating a virtual payment card, the virtual payment card having a unique identifier and a virtual payment card balance;
linking, with a processor, a primary account number of a physical payment card to the virtual payment card;
receiving a financial transaction request message, via a network interface, the financial transaction request message containing a transaction amount and the primary account number of the physical payment card;
substituting, with the processor, the primary account number of the physical payment card with the unique identifier of the virtual payment card;
approving or declining a financial transaction for the transaction amount using the substituted unique identifier;
transmitting, via the network interface, an approval message, when the financial transaction is approved; and
transmitting, via the network interface, a decline message, when the financial transaction is declined.

2. The method of claim 1, further comprising:
electronically receiving, via the network interface, a contribution to the virtual payment card balance from a contributor.

3. The method of claim 2, further comprising:
electronically receiving, via the network interface, multiple contributions to the virtual payment card balance from a plurality of contributors.

4. The method of claim 3, further comprising:
notifying the plurality of contributors of the financial transaction after the financial transaction has occurred.

5. The method of claim 4, further comprising:
calculating, with the processor, an amount to be returned to each of the plurality of contributors after the financial transaction has occurred.

6. The method of claim 5, further comprising:
calculating, with the processor, a proportional amount to be returned to each of the potential contributors after the financial transaction has occurred.

7. The method of claim 5, further comprising:
calculating, with the processor, an approximate equal amount to be returned to each of the potential contributors after the financial transaction has occurred.

8. An apparatus comprising:
a processor configured to create a virtual payment card, the virtual payment card having a unique identifier and a virtual payment card balance, to link a primary account number of a physical payment card to the virtual payment card; and
a network interface configured to receive a financial transaction request message, the financial transaction request message containing a transaction amount and the primary account number of the physical payment card;
wherein the processor is further configured to substitute the primary account number of the physical payment card with the unique identifier of the virtual payment card, and to approve or decline a financial transaction for the transaction amount using the substituted unique identifier; and
wherein the network interface is further configured to transmit an approval message, when the financial transaction is approved, and to transmit a decline message, when the financial transaction is declined.

9. The apparatus of claim 8, wherein the network interface is further configured to electronically receive a contribution to the virtual payment card balance from a contributor.

10. The apparatus of claim 9, wherein the network interface is further configured to electronically receive multiple contributions to the virtual payment card balance from a plurality of contributors.

11. The apparatus of claim 10, wherein the network interface is further configured to electronically notify the plurality of contributors of the financial transaction after the financial transaction has occurred.

12. The apparatus of claim 11, wherein the processor is further configured to calculate an amount to be returned to each of the plurality of contributors after the financial transaction has occurred.

13. The apparatus of claim 12, wherein the processor is further configured to calculate a proportional amount to be returned to each of the potential contributors after the financial transaction has occurred.

14. The apparatus of claim 12, wherein the processor is further configured to calculate an approximate equal amount to be returned to each of the potential contributors after the financial transaction has occurred.

15. A non-transitory computer readable medium encoded with data and instructions, when executed by a computing device the instructions causing the computing device to:
create a virtual payment card, the virtual payment card having a unique identifier and a virtual payment card balance;
link, with a processor, a primary account number of a physical payment card to the virtual payment card;
receive a financial transaction request message, via a network interface, the financial transaction request message containing a transaction amount and the primary account number of the physical payment card;
substitute, with the processor, the primary account number of the physical payment card with the unique identifier of the virtual payment card;
approve or decline a financial transaction for the transaction amount using the substituted unique identifier;
transmit, via the network interface, an approval message, when the financial transaction is approved; and
transmit, via the network interface, a decline message, when the financial transaction is declined.

16. The non-transitory computer readable medium of claim 15, further comprising:
electronically receive, via the network interface, a contribution to the virtual payment card balance from a contributor.

17. The non-transitory computer readable medium of claim 16, wherein the instructions further cause the computing device to:
electronically receive, via the network interface, multiple contributions to the virtual payment card balance from a plurality of contributors.

18. The non-transitory computer readable medium of claim 17, wherein the instructions further cause the computing device to:
notify the plurality of contributors of the financial transaction after the financial transaction has occurred.

19. The non-transitory computer readable medium of claim 18, wherein the instructions further cause the computing device to:
calculate, with the processor, an amount to be returned to each of the plurality of contributors after the financial transaction has occurred.

20. The non-transitory computer readable medium of claim 19, wherein the instructions further cause the computing device to:
calculate, with the processor, a proportional amount to be returned to each of the potential contributors after the financial transaction has occurred.
